(19) United States
(12) Patent Application Publication
(10) Pub. No.: US 2020/0138227 A1
(43) Pub. Date: May 7, 2020

(54) BELL PEPPER DECORING MACHINE

(71) Applicants: Ying ZENG, Tokyo (JP); Kaito Morita, Tokyo (JP); Nasa TAKANO, Tokyo (JP); Toko KAMIMATE, Chiba Pref. (JP); Masakazu HIRANO, Saitama Pref (JP); Risa OKAZAKI, Tokyo (JP); Haruna OKAMURA, Kanagawa Pref. (JP); Kakeru OIGAWA, Chiba Pref. (JP); Momoko MIYATA, Kanagawa Pref. (JP); Rei MASUDA, Tokyo (JP); Daisuke TAKANASHI, Chiba Pref. (JP)

(72) Inventors: Ying ZENG, Tokyo (JP); Kaito Morita, Tokyo (JP); Nasa TAKANO, Tokyo (JP); Toko KAMIMATE, Chiba Pref. (JP); Masakazu HIRANO, Saitama Pref (JP); Risa OKAZAKI, Tokyo (JP); Haruna OKAMURA, Kanagawa Pref. (JP); Kakeru OIGAWA, Chiba Pref. (JP); Momoko MIYATA, Kanagawa Pref. (JP); Rei MASUDA, Tokyo (JP); Daisuke TAKANASHI, Chiba Pref. (JP)

(21) Appl. No.: 16/736,841

(22) Filed: Jan. 8, 2020

(51) Int. Cl. A47J 25/00

(52) U.S. Cl. CPC A47J 25/00

(57) ABSTRACT

A bell pepper decoring machine includes a cylinder-shaped hollow body including a slit formed in a longitudinal direction on the surface of the body, a serrated edge formed at one end of the body wherein serrated edge includes a plurality of blades, each of which is spaced equally, a core receiver having a receiving plate and a columnar rod connected at its one end to the center of the back side of the receiving plate wherein the core receiver is stored in the body, a height adjuster located in the slit and connected to the core receiver wherein the height adjuster is moved within the slit and wherein the core receiver is also moved in the body in conjunction with the movement of the height adjuster, a supporting plate formed at on the other end of the body, and a cutter connected to the other end of the rod with a connecter.

### BACKGROUND OF THE INVENTION

### 1. Field of the invention

This invention has been made by the members of MIMURA Seminar, College of Law, Nihon Univ. as a team. The present invention relates to a bell pepper decoring machine enable to slice a body of a bell pepper after removing its seeds.

### 2. Description of the related art

As shown in FIG.3, a bell pepper decoring device 200 in the related art includes a cylinder-shaped hollow body 210 with a serrated edge 220 at its lower edge and a handle 230 at its other end for being held by a used. On the inner peripheral surface of the body 210, some inclined triangular blades 240 are formed at desired intervals wherein a tip of each blade 240 is extended toward the center of the body 210 so that no resistance occurs at the time of decoring of the bell pepper. In addition, the core can be caught by the 240 in pulling it out. Further, the inside of the body acts as a core storage portion 250. According to the device 200 in the related art, by inserting the body 210 into the bell pepper after cutting the calyx thereof using the serrated edge 220, it is possible to remove-the core in the bell pepper completely.

However, according to the device 200 in the related art, it is possible to remove the core completely while it cannot slice the bell pepper after removing the core. For this reason, the decored pepper must be cut with a knife. Thus, after using the device 200 both the device 200 for decoring and the knife for slicing must be cleaned after using them. For the above reasons, there was a desire for an instrument with the ability to core and cut bell peppers.

In addition, in the conventional bell pepper decoring device 200, the bell pepper core remains in the core storage portion 250 after the bell pepper core is pulled out, so the garbage after the bell pepper core is pulled out by hand. For this reason, it is expected to develop a new device having functions for both decoring and slicing.

### SUMMARY OF THE INVENTION

An objective of the present invention is to resolve the above described problem and provide a bell pepper decoring machine including a cylinder-shaped hollow body including a slit formed in a longitudinal direction on the surface of the body, a serrated edge formed at one end of the body wherein serrated edge includes a plurality of blades, each of which is spaced equally, a core receiver having a receiving plate and a columnar rod connected at its one end to the center of the back side of the receiving plate wherein the core receiver is stored in the body, a height adjuster located in the slit and connected to the core receiver wherein the height adjuster is moved within the slit and wherein the core receiver is also moved in the body in conjunction with the movement of the height adjuster, a supporting plate formed at on the other end of the body, and a cutter connected to the other end of the rod with a connecter.

### BRIEF DESCRIPTION OF THE DRAWINGS

The above-described and other objects and features of the present invention will be apparent from the following embodiments, which are described in reference to the accompanying drawings, in which:

FIG. 1A is a perspective view showing an entire bell pepper decoring machine 100, according to an embodiment of the invention;

FIG. 1B, is a top view of the bell pepper decoring machine 100, according to an embodiment of the invention;

FIG. 1C is a bottom view of the bell pepper decoring machine 100, according to an embodiment of the invention;

FIG. 1D is also perspective view of the bell pepper decoring machine 100 when a receiver is pushed, according to an embodiment of the invention;

FIGS. 2A through 2E are perspective views showing operations of use for the bell pepper decoring machine 100 according to the invention; and

FIG. 3 is a perspective view of the bell pepper decoring machine 100 in the related art.

### DETAILED DESCRIPTION OF THE PREFERRED EMBODIMENT

A preferred embodiment of the invention as to a bell pepper decoring machine 200 is explained together with drawings as follows. In each drawing, the same reference numbers designate the same or similar components through all embodiments.

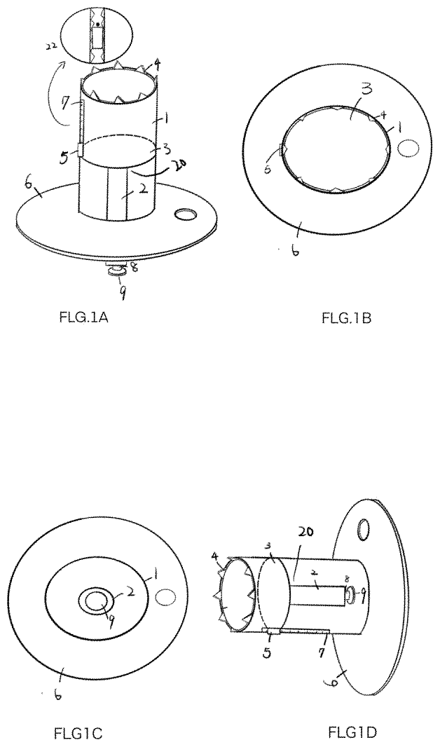

As shown in FIGS. 1A through 1C, the bell pepper decoring machine 100 of the present invention includes a cylinder-shaped hollow body 1 with a serrated edge 4 at its one end wherein a slit 7 is formed in a longitudinal direction on its surface, a supporting plate 6 formed on the other end of the body 1, a core receiver 20 having a receiving plate 3 and a columnar rod 2 connected at its one end to the center of the back side of the receiving plate 3 wherein the core receiver 20 is located in the body 1, a disk-shaped cutter 9 connected to the columnar rod 2 by a connector 8 at its other end and a height adjuster 5 connected to the plate 3 and movable in the slit 7. In the slit 7, seven (7) notches 22 each of which is formed at the side surface in the slit and is spaced with 1 mm are formed. By formed the notches 22, it is possible to change the thickness of the sliced bell pepper, as described later.

The supporting plate 6 having the front and back surfaces includes a through hole 6A, By forming the through hole 6A, it is possible to hang the bell pepper decoying machine 100 on a wall or the like. When the cutter 9 is housed inside the main body 1, the bell pepper decoring machine 100 can be stood vertically with a supporting plate 6, which is formed perpendicular to the body 1. The height adjuster 5 is projected from the surface of the body 1 and can be moved within the slit 7.

As shown in FIGS. 1A, 1B and 1C, the body 1 is made of a cylindrical and hollow plastic tube having a diameter of 30 mm, a thickness of 5 mm, and a length of 130 mm. The shape of the serrated edge 4 is formed in a plurality of regular triangle-shaped blade, each having 8mm on each side and is made of plastic. Each of blades is spaced equally. The receiving plate 3 is made of plastic having a diameter of 28 mm and a thickness of 2 mm. The rod 2 connected to the plate 3 is made of cylindrical plastic having a diameter of 10 mm and a length of 80 mm. The height adjuster 5 is made of plastic having a length of 10 mm and a thickness of 10 mm, and includes bulges at its both side for coupling with one of notches 22 formed in the slit 7. The slit 7 is formed with a length of 80 mm and a width of 11 mm. The connecter 8 has a diameter of 20 mm and a thickness of 10 mm and is formed of a plastic.

The supporting plate 6 is made of plastic having a diameter of 60 mm and a thickness of 5 mm. The connecter 8 is made of plastic having a diameter of 5 mm and a thickness of 2 mm. The cutter 9 is made of a circular metal having a diameter of 25 mm and a thickness of 2 mm.

As shown in FIG. 1D by moving the height adjuster 5 within the slit 7 to the position closed to the serrated edge 4 when not in use, the cutter 9 can be stored in the body 1 so that some accidental injuries by the cutter 9 can be avoidable.

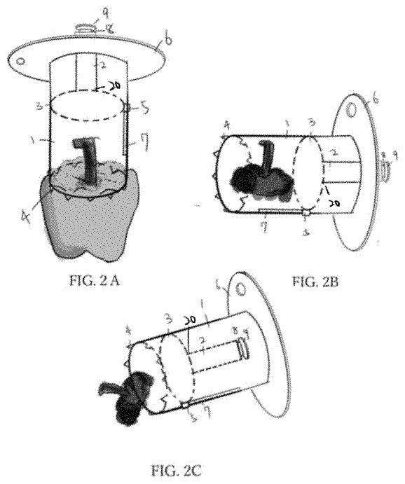

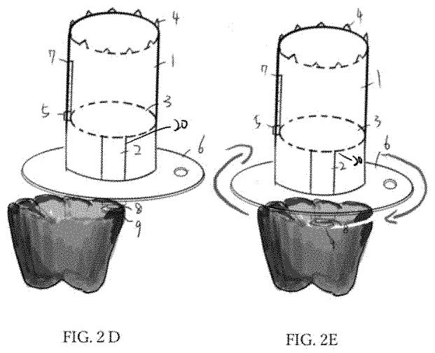

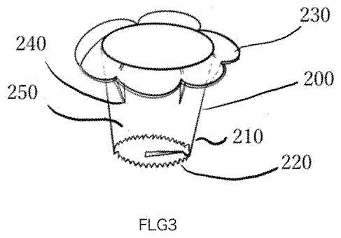

As shown in FIGS. 2A, 2B, and 2C, the bell pepper decor ng machine 100 of the present invention formed as described above is used as follows. In the initial state, the height adjuster 5 is placed at the end in the slit 7, that is, the position of the height adjuster 5 is located farthest from the serrated edge 4. Thereby, a sufficient space is secured inside the body 1. In this state, the body 1 having the serrated edge 4 stabbed into the bell pepper around calyx from the above, and then, the body 1 is rotated. As a result, the core and seeds of the bell pepper are separated from the body of the bell pepper, and the detached core and the seeds are stored on the core receiver 20 in the body 1. Then, the body 1 is extracted from the body of the bell pepper. Next, the height adjuster 5 is moved within the slit 7 to the location closest to the serrated edge 4. Since the height adjuster 5 and the core receiver 20 are interlocked, the core receiver 20 also is moved within the body 1 to a position near the serrated edge. As a result, the seeds and the core stored in the body 1 are pushed out by the plate 3 of the core receiver 20 and can be discharged from the body 1 to the outside. In this state, the cutter 9 formed at the other end of the rod 2 is housed inside the body 1.

Next, the slicing operation of the careless and the seedless bell pepper is carried out. As shown in FIG. 2D, the location of the height adjuster 5 is set back to the initial state by moving within the slit 7. Thereby, the cutter 9 formed on the body connecting with the connector 8 is exposed to the outside. Next, the tip of the bell pepper is placed on a cutting board, and the bell pepper is sandwiched between the cutting board and the back surface of the supporting plate 6.

Further, as shown in FIG. 2E, the cutter 9 is introduced from the inner surface of the body of the bell pepper to word its outer surface, and the bell pepper decoring machine 100 is moved to draw a circle from the inside along the surface of the bell pepper. So, the bell pepper is sliced into round by the cutter. In addition, the thickness of the sliced bell pepper is determined by the position where the connecter 8 is formed.

In the case that the connecting 8 and the rod 2 are formed in the relations such as bolt and nut, the cutter 9 can be set at the desired position by rotating the connector 8 on the rod 2. As the result, the bell peppers can be sliced on the desired thickness.

While the invention has been described with reference to illustrative embodiments, this description is not intended to be construed in a limiting sense. Thus, shapes, size and physical relationship of each component are roughly illustrated so the scope of the invention should not be construed to be limited to them. Further, to clarify the components of the invention, hatching is partially omitted in the cross-sectional views.

Various other modifications of the illustrated embodiment will be apparent to those skilled in the art on reference to this description. Therefore, the appended claims are intended to cover any such modifications or embodiments as fall within the true scope of the invention.

We claim:

1. A bell pepper decoring machine, comprising:
a cylinder-shaped hollow body including a slit formed in a longitudinal direction on the surface of the body;
a serrated edge formed at one end of the body, wherein serrated edge includes a plurality of blades, each of which is spaced equally;
a core receiver having a receiving plate and a columnar rod connected at its one end to the center of the back side of the receiving plate, wherein the core receiver is stored in the body, a height adjuster located in the slit and connected to the core receiver, wherein the height adjuster is moved within the slit, and wherein the core receiver is also moved in the body in conjunction with the movement of the height adjuster;
a supporting plate formed at on the other end of the body; and
a cutter connected to the other end of the rod with a connecter.

2. A bell pepper decoring machine as claimed in claim 1 the further comprising;
a plurality of notches formed in the slit at the side surface whereby the height adjuster is coupled with one of the notches so that the location of the cutter can be adjusted.

3. A bell pepper decoring machine as claimed in claim 2, wherein the cutter is formed in disk-shaped.

4. A bell pepper decoring machine as claimed in claim 1, wherein the diameter of the receiving plate equals to that of the body.

5. A bell pepper decoring machine as claimed in claim 2 wherein the diameter of the receiving plate equals to that of the body.

6. A bell pepper decoring machine as claimed in claim 2, wherein the diameter of the receiving plate equals to that of the body.
